(19) United States
(12) Patent Application Publication
(10) Pub. No.: US 2025/0341323 A1
(43) Pub. Date: Nov. 6, 2025

(54) CEILING-MOUNTED RADIATING ELEMENTS

(71) Applicant: Kermi GmbH, Plattling (DE)

(72) Inventors: Georg Drexler, Rimbach (DE); Veronika Gerbrich, Deggendorf (DE); Roland Hofinger, Deggendorf (DE); Johannes Reichert, Plattling (DE); Günter Schmalhofer, Deggendorf (DE)

(73) Assignee: Kermi GmbH, Plattling (DE)

(21) Appl. No.: 17/919,182

(22) PCT Filed: Apr. 12, 2021
(86) PCT No.: PCT/EP2021/059435

§ 371 Date: Oct. 14, 2022

(30) Foreign Application Priority Data
Apr. 15, 2020 (DE) 10 2020 204 727.8

(51) Int. Cl. F24F 5/00; F16L 21/08; F24D 19/00

(52) U.S. Cl. CPC F24F 5/0003; F16L 21/08; F24D 19/0017; F24F 5/0092; F24D 2220/06; F24F 2221/02; F24F 2221/14; F24F 2221/36; F24F 2221/54

(57) ABSTRACT

Ceiling-mounted radiating elements for heating or cooling rooms, comprising means for connecting the ceiling-mounted radiating elements together, wherein the ceiling-mounted radiating elements comprise at least one through-flow pipe for a heating or cooling medium, and radiating surfaces are arranged radially around said pipe, wherein to connect two ceiling-mounted radiating elements (1, 1′), at least one core piece (2) is provided which allows an operationally tight connection of the through-flow pipes (3) of two ceiling-mounted radiating elements (1, 1′) to be connected, and at least one mounting rail (4) for positioning at least one connecting part (5) is provided, which locks and secures the ceiling-mounted radiating elements (1, 1′) when a connection is produced.

The invention concerns ceiling-mounted radiating elements with means for connecting the profiles together and to the pipe network, according to the features of claim 1. Ceiling-mounted radiating elements serve for heating or cooling rooms, and to this end, heating or cooling medium flows through the elements. Such elements or profiles are known and are usually extrusions. They have a through-flow pipe for the heating or cooling medium and radiating surfaces arranged thereon. The radiating profiles are usually provided with fixing strips or rails for brackets, wherein the ceiling-mounted radiating profile is usually attached to the bracket by a fixing rail. For example, GB 2 262 548 A describes a ceiling-mounted radiator of the above-mentioned type in which a through-flow pipe containing the stream of heating or cooling medium is shielded by a radiating surface.

DE 196 17 718 A1 discloses a ceiling-mounted radiator of the described type which comprises a through-flow pipe with several radiating surfaces with fixing strips. According to WO 91 13294, a through-flow pipe is also integrated in structural elements which have widely varying configurations for radiating. The manner in which the profiles are connected to a ceiling-mounted radiator consisting of several profiles is not described in said prior art.

At present, the ceiling-mounted radiating profiles-usually consisting of an aluminum alloy
are connected by means of screw-in coupling and connecting elements. These are conventional press fittings made of galvanized steel or stainless steel.

The connection method is well established in the trade but offers potential for improvement in the areas of:
corrosion resistance,
appearance, and
installation time (e.g. in large buildings).

For this, a thread must be made in the profile in the factory. The surface layer to be protected in the connecting region is removed here, so that unprotected material and material of the connection components can come into contact with the medium at one point, which can lead to corrosion.

When galvanized fittings are used, the present standard VDI2035 allows a very narrow tolerance range for the water composition. The stainless steel design, which allows a wider tolerance range of the medium, has a significantly higher sale price.

For installation, also suitable pressing tools are required with manufacturer-specific pressing geometry.

Furthermore, the distance between two connected profiles gives an appearance of industrial character, which is not desired in buildings with high design standards. For this reason also, module lengths of up to 12 m are preferred.

A further disadvantage is that the connection with press fittings cannot be separated or profiles removed without destruction.

The object of the invention is therefore to improve the connection techniques known from the prior art for ceiling-mounted radiating profiles. According to the invention, this object is achieved by the features of claim 1.

The invention accordingly comprises a ceiling-mounted radiating element, in particular a ceiling-mounted radiating profile, for heating or cooling rooms, comprising means for connecting the ceiling-mounted radiating elements together, wherein the ceiling-mounted radiating elements comprise at least one through-flow pipe for a heating or cooling medium, and radiating surfaces are arranged radially around said pipe.

According to the invention, it is provided that at least one core piece is provided which allows an operationally tight connection of the through-flow pipes of two ceiling-mounted radiating elements to be connected, and at least one mounting rail for positioning at least one connecting part is provided, which locks and secures the ceiling-mounted radiating elements when a connection is produced.

According to a further feature of the invention, it is provided that the core piece has ring/collar/stop/centering elements arranged in the middle, and at least one seal is arranged on both sides at a defined distance. This guarantees adequate tightness. According to another feature, it is provided that the mounting rails and the connecting parts have mechanisms in active co-operation. These guarantee security against slippage and twisting of the ceiling-mounted radiating elements. Advantageously, it is furthermore provided that the mounting rails can be used as connecting elements for a ceiling fixing and/or for mounting of additional attachments. According to a further feature, it is possible for two ceiling-mounted radiating profiles to be connected together via a corner transition piece, wherein the corner transition piece has at least one seal on both sides at a defined distance. This guarantees adequate tightness. Pipe clamps are provided on both sides of the corner transition piece, at which connecting parts are arranged which are suitable for guiding in the mounting rails of the ceiling-mounted radiating elements to be connected at a corner.

It is furthermore advantageously provided that the ceiling-mounted radiating profiles comprise at least one through-flow pipe for a heating or cooling medium, and several radiating surfaces are arranged radially around said through-flow pipe, wherein the arrangement of the radiating surfaces around the through-flow pipe is possible in all conceivable variants, wherein at least two radiating surfaces are positioned symmetrically or asymmetrically around the through-flow pipe.

It is possible here that the mounting rails for positioning of at least one connecting part are arranged directly radially offset around the circumference of the through-flow pipe. Alternatively, it is particularly advantageously possible that the mounting rails for positioning of at least one connecting part are arranged at the free ends of the radiating surfaces.

The ceiling-mounted radiating profiles can advantageously be fluidically connected in series one behind the other and/or around corners or in parallel (cascade) via a collector.

With the ceiling-mounted radiating profile with connecting system according to the invention, the disadvantages described above may be overcome. The features of the ceiling-mounted radiating profile with connecting system allow connection of the profiles with a defined intermediate gap or with no intermediate gap.

The ceiling-mounted radiating profile with connecting system, depending on installation type, comprises the following components:
1. Ceiling-mounted radiating profile modules
2. Core piece with seals
   sealing function
   hydraulic interface
   spacing
   The spacing may be achieved either via the connecting parts or via the core piece. Various additional elements such as a retaining ring, O-ring, molding integrated in the structure, etc. may be added to the core piece or connecting part.
3. Connecting part for ceiling-mounted radiating profile
   mechanical interface
   absorption of forces
   spacing
   interface to ceiling connection
   control function
   The control function is implemented by control elements/components which are integrated directly on/in the connecting parts. These elements/components must be clearly visible to the installing engineer during the mounting process. This ensures that the fixing components are tightened and the connection is secure. A force fit is created between the mounting rail and connecting part. In the head region of the setscrew, a paint marking is made which disappears when the setscrew is screwed into the connecting part. This ensures a technical/visual control of the form fit and force fit.
4. Adapter for supply/return with connectors/external threads for connection to the pipe network
5. Special components and covering accessories, e.g. for technical connection components.

The individual components are described in detail below.
1. The ceiling-mounted radiating profile module has a performance-optimized and protected profile geometry. A chamfer/jointing slope with a defined angle is made in the profiles in order to guarantee simple and damage-free mounting of the core piece. The connecting region must be free from burrs and foreign bodies/damage. Suitable tools and devices are necessary for the chamfer.
   There is no longer a need for threads in the connecting region, as in the previous solutions.
   Guide rails are provided on the top and bottom of the water-conducting pipe, which are structurally integrated into the profiles and may be used for fixing the profiles to the ceiling and for mounting components (lamps etc.) underneath. In addition, the rails serve to connect two profile modules together by means of connecting parts.
2. The core piece creates the operationally tight connection between two profile modules. The ring/collar/stop/centering element arranged in the middle allows rapid centralized installation. At least one seal is arranged at a defined distance on both sides, which guarantees adequate tightness. The function is divided into mechanical connection and seal. This division allows the use of simple and economic components.
   Mounting:
   Mounting requires no tools and no additional sealing material (hemp, sealing tape, liquid sealant etc.). Normal hand force is sufficient. The great ease of mounting also allows installation at locations with difficult access and under difficult mounting conditions. Non-destructive removal is possible.
   Hydraulics:
   The core piece has an optimized flow geometry which exerts less influence on the hydraulics of the installation than conventional systems (very low pressure loss and turbulence).
   Corrosion:
   The core piece consists of permanently corrosion-resistant material (stainless steel, polyamide, aluminum etc.).
   Because of the optimized flow geometry/design, areas with water build-up and hence corrosion formation are avoided.
3. The connecting part may fulfil several functions as follows:
   a) holding the profile modules together against slipping apart,
   b) stable guidance and alignment when joining profile modules,
   c) security against twisting of the profile modules,
   d) (in some cases) as a connecting element for ceiling fixing or additional attachments.
   This fixing component is positioned in the mounting rail of the ceiling-mounted radiating profiles. It is secured against displacement in the mounting rail by form fit and force fit (e.g. setscrew etc.). Alternatively, the connecting part may be secured via a snap-fit or push-fit mechanism.
   The fixing method allows simple and non-destructive dismantling of the connection between modules.
   After installation, the safety check must be performed by integrated control elements (e.g. sealing paint on setscrew, adhesive tape etc.), to ensure that the form fit and force fit are secure.
4. The adapter for supply and return forms the interface of the ceiling-mounted radiating profile sections to the system components such as conduction pipes, shut-off valves, volume flow control valves etc.
   The interface may be produced e.g. with a connecting thread (internal/external), pressing geometry or pipe piece.
   Designed unilaterally, like the core piece.
   The adapter may also be equipped with elements which allow simultaneous connection of the profile (e.g. insert pipe/lance valve).
   Fixing to the profile module takes place via the above-described connecting piece.
   Because of the optimized flow geometry/design, areas with water build-up and hence corrosion formation are avoided.
5. For particular installation situations, special components or particular covering parts are required.
   a) corner connection: two profiles are connected together with a corner transition piece (various angles) and secured against displacement.
   b) connection of several profiles/collectors using cascading components. Cascading may achieve a higher performance than a single profile module. By mounting several profiles closely in parallel with one another, a multiple of the performance is achieved. The mounting time is reduced since there is no need to suspend many individual profile sections, but merely a few in assembled blocks (cascade).

### System Advantages:

easier mounting at great height (previously requiring special pressing tools),
visual alignment not required/automatic,
no special tools required,
easier on-site handling because of smaller modular elements (previously, max. 12 m),
non-destructive dismantling (previously, press fitting destroyed on dismantling),
spacing between modules jointless (0 cm) or with defined joint (previously, spacing at least 7 cm, depending on press fittings).

No additional sealing materials required.

The invention is described in more detail below with reference to exemplary embodiments. In the drawings:

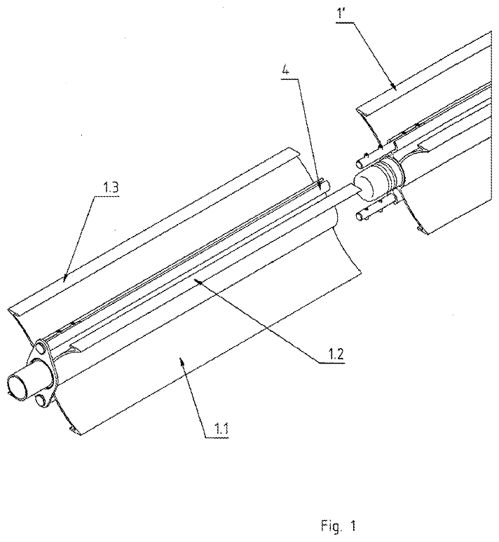

FIG. 1 shows a perspective view of two ceiling-mounted radiating profiles to be connected together;

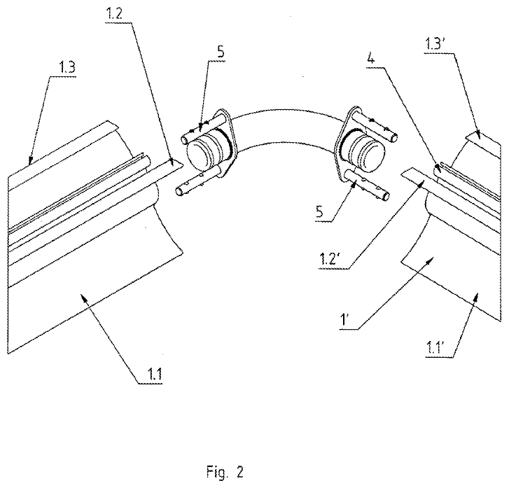

FIG. 2 shows a perspective view of two ceiling-mounted radiating profiles to be connected together with a corner transition piece;

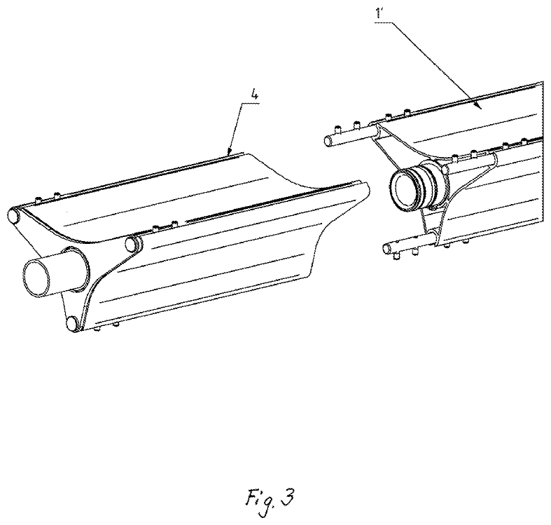

FIG. 3 shows a perspective view of two ceiling-mounted radiating profiles to be connected together in another embodiment;

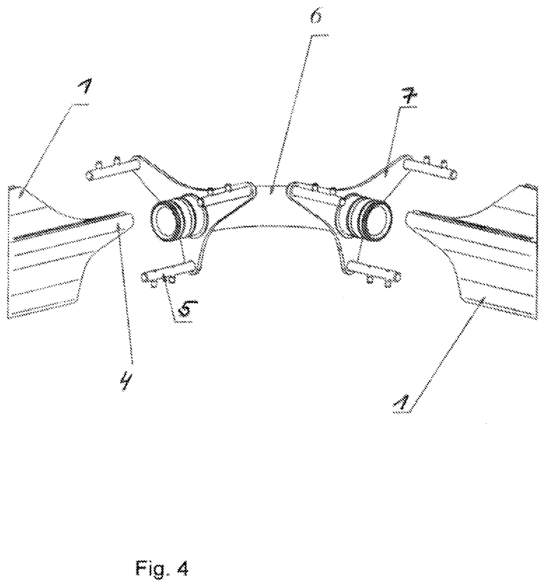

FIG. 4 shows a perspective view of two ceiling-mounted radiating profiles to be connected together according to FIG. 3 with a corner transition piece;

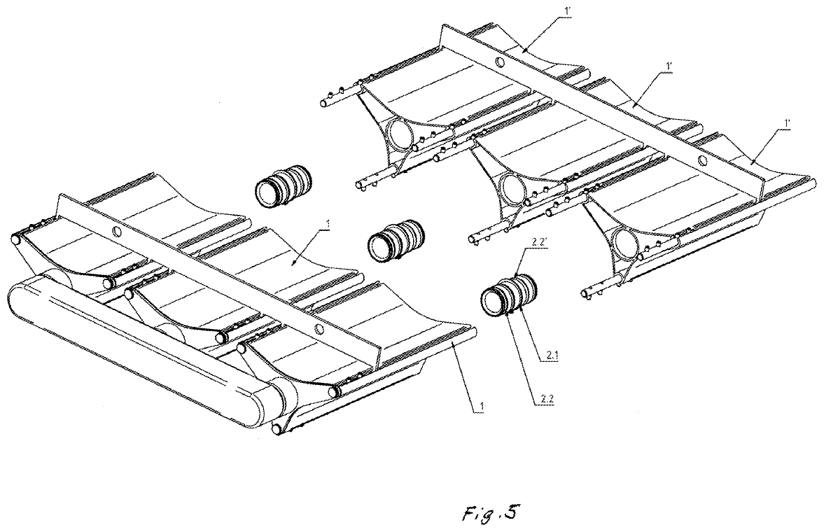

FIG. 5 shows an exemplary illustration of a cascade circuit of ceiling-mounted radiating profiles with a collector.

FIG. 1 shows two ceiling-mounted radiating profiles (1, 1′) to be connected together. The radiating surfaces (1.n, 1n+1) are arranged in an X-shape around the through-flow pipe (3), wherein here four radiating surfaces are provided. In this variant, two mounting rails (4) arranged vertically opposite one another are provided for positioning the connecting parts (5), and lock and secure the ceiling-mounted radiating profiles (1, 1′) when the connection is produced. The core piece (2) has ring/collar/stop/centering elements (2.1) arranged in the middle on both sides. Furthermore, seals (2.2, 2.2′) are arranged which guarantee adequate tightness. The mounting rails (4) and the connecting pieces (5) have mechanisms (4.1) in active co-operation which guarantee security against slipping and twisting of the ceiling-mounted radiating profiles (1, 1′). Alternatively, it is also possible that the mounting rails (4) can be used as connecting elements for ceiling fixing and/or for mounting additional attachments (lamps). The mounting rails (4) for positioning the connecting parts (5) are here arranged directly radially offset around the circumference of the through-flow pipe (3).

FIG. 2 shows how two ceiling-mounted radiating profiles (1, 1′) are connected together via a corner transition piece (6), wherein the corner transition piece (6) has at least one seal (6.1, 6.2′) on both sides, which guarantees adequate tightness, and pipe clamps (7, 7′) are provided on both sides of the corner transition piece (6), at which connecting parts (5) are arranged which are suitable for guidance in the mounting rails (4) of the ceiling-mounted radiating profiles (1, 1′) to be connected together at a corner.

The arrangement of the radiating surfaces (1.n, 1.n+1) around the through-flow pipe (3) is possible in all conceivable variants, wherein at least two radiating surfaces are positioned symmetrically or asymmetrically around the through-flow pipe (3). Further variants of the arrangement and formation of the radiating surfaces are shown in FIGS. 3 to 5. As well as an X-shaped arrangement, Y-shaped or star-shaped arrangements of the radiating surfaces around a through-flow pipe are possible, as is the arrangement of flat radiating surfaces (ceiling-mounted panel). The through-flow pipe 3 may also have cross-sectional forms other than circular.

In the variants shown in FIGS. 3 and 4, the mounting rails (4) for positioning of the connecting parts (5) are arranged at the free ends of the radiating surfaces (1.n, 1n+1).

The ceiling-mounted radiating profiles or elements (1,1′) can be fluidically connected in series one behind the other and/or around corners or in parallel via a collector (10). A cascade circuit of several ceiling radiating profiles is shown in FIG. 5. Here the profiles are connected via a collector 10.

1. Ceiling-mounted radiating elements for heating or cooling rooms, comprising means for connecting the ceiling-mounted radiating elements together, wherein the ceiling-mounted radiating elements comprise at least one through-flow pipe for a heating or cooling medium, and at least one radiating surface,
characterized in that to connect two ceiling-mounted radiating elements (1, 1′),
at least one core piece (2) is provided which allows an operationally tight connection of the through-flow pipes (3) of two ceiling-mounted radiating elements (1, 1′) to be connected,
at least one mounting rail (4) for positioning at least one connecting part (5) is provided, which locks and secures the ceiling-mounted radiating elements (1, 1′) when a connection is produced.

2. The ceiling-mounted radiating elements as claimed in claim 1, characterized in that the core piece (2) has ring/collar/stop/centering elements (2.1) arranged in the middle, with at least one seal (2.2, 2.2′) arranged on both sides which guarantees adequate tightness.

3. The ceiling-mounted radiating elements as claimed in claims 1 and 2, characterized in that the mounting rails (4) and the connecting parts (5) have mechanisms (4.1) in active co-operation, which guarantee security against slippage and twisting of the ceiling-mounted radiating elements (1, 1′).

4. The ceiling-mounted radiating elements as claimed in any of claims 1 to 3, characterized in that the mounting rails (4) can be used as connecting elements for a ceiling fixing and/or for mounting of additional attachments such as e.g. lamps.

5. The ceiling-mounted radiating elements as claimed in any of claims 1 to 4, characterized in that two ceiling-mounted radiating elements (1, 1′) are connected together via a corner transition piece (6), wherein the corner transition piece (6) has at least one seal (6.1, 6.1′) on both sides, which guarantees adequate tightness, and pipe clamps (7, 7′) are provided on both sides of the corner transition piece (6), at which connecting parts (5) are arranged which are suitable for guiding in the mounting rails (4) of the ceiling-mounted radiating elements (1, 1′) to be connected at a corner.

6. The ceiling-mounted radiating elements as claimed in any of claims 1 to 5, characterized in that the ceiling-mounted radiating elements (1,1′) comprise at least one through-flow pipe (3) for a heating or cooling medium, and several radiating surfaces (1.n, 1n+1) are arranged radially around said through-flow pipe (3), wherein the arrangement of the radiating surfaces (1.n, 1.n+1) around the through-flow pipe (3) is possible in all conceivable variants, wherein at least 2 radiating surfaces are positioned symmetrically or asymmetrically around the through-flow pipe (3).

7. The ceiling-mounted radiating elements as claimed in any of claims 1 to 6, characterized in that the mounting rails (4) for positioning of at least one connecting part (5) are arranged directly radially offset around the circumference of the through-flow pipe (3).

8. The ceiling-mounted radiating elements as claimed in any of claims 1 to 6, characterized in that the mounting rails (4) for positioning of at least one connecting part (5) are arranged at the free ends of the radiating surfaces (1.n, 1n+1).

9. The ceiling-mounted radiating elements as claimed in any of claims 1 to 8, characterized in that the ceiling-mounted radiating profiles (1,1′) can be fluidically connected in series one behind the other and/or around corners or in parallel via a collector (10).
